(19) United States
(12) Patent Application Publication
(10) Pub. No.: US 2006/0171376 A1
(43) Pub. Date: Aug. 3, 2006

(54) Providing services in a communications system

(75) Inventor: Uwe Schwarz, Veikkola (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/132,284

(22) Filed: May 19, 2005

(30) Foreign Application Priority Data
Jan. 28, 2005 (GB) GB 0501829.6

(51) Int. Cl. H04L 12/66; H04L 12/56

(52) U.S. Cl. 370/352; 370/401

(57) ABSTRACT

In a method for providing a further service for user equipment provided with a circuit switched service in a first communication system a request for a packet data service is first received in the first communication system. The user equipment is then transferred to a second communication system before establishing a data connection for the requested packet data service in the first communication system. A request for the packet data service is processed in the second communication system, where after the requested packet data service is provided for the user equipment by the second communication system.

### BACKGROUND OF THE INVENTION

1. Field of the Invention

The present disclosure relates to providing services in a communications systems, and more particularly to transfer of multimode user equipment from a communications system to another.

2. Description of the Related Art

A communication system can be seen as a facility that enables communication sessions between two or more entities such as user equipment and/or other nodes associated with the communication system. The communication may comprise, for example, communication of voice, data, multimedia and so on. A user equipment connected to a communication system may, for example, be provided with a two-way telephone call or multi-way conference call or with a data connection. In addition voice call services, various other services, for example multimedia services or other data services, may be provided for a user. A user equipment may communicate packet data to and from a server entity, or between two or more user equipments.

A communication system typically operates in accordance with a given standard or specification which sets out what the various entities associated with the system are permitted to do and how that should be achieved. For example, the standard or specification may define if a user equipment is provided with a circuit switched service or a packet switched service or both. Communication protocols and/or parameters which shall be used for the connection are also typically defined. For example, the manner how the user equipment can access the communication system and how communication shall be implemented between the user equipment and the elements of the communication network is typically based on predefined communication protocols. In other words, a specific set of “rules” on which the communication can be based on needs to be defined to enable the user equipment to communicate via the communication system.

Communication systems proving wireless communication for user equipment are known. These systems are commonly referred to as mobile systems, although in certain systems the mobility may be restricted to substantially small areas. An example of the mobile systems is the public land mobile network (PLMN). Another example is a mobile system that is based, at least partially, on use of communication satellites. Mobile communications may also be provided by means of other types of systems, such as by means of wireless local area networks (WLAN).

In a typical mobile system the user equipment communicates via a station of the communications, commonly referred to as a base station. A station provides user equipment with access to the communication system. This access area so provided is commonly referred to as a cell. A user equipment may be in wireless communication with two or more base stations at the same time. A user equipment may also be configured to communicate with base stations of different networks, i.e. are adapted for operation in multi-radio environments. Communication on the wireless interface between the user equipment and the base station(s) can be based on appropriate communication protocols.

The operation of the apparatus of an network is controlled by an appropriate control arrangement commonly including a number of various control entities with different functions. Control of the access network side (i.e. the cells) and the core network side of a network is typically separated.

Multi-mode user equipment are also known. In brief, a multi-mode user equipment refers to terminal equipment adapted to operate in accordance with more than one communications standard. Thus multi-mode user equipment may communicate via a plurality of communication networks. An example of multimode-mode user equipment is a user equipment configured to operate in 2G and 3G networks.

With steadily increasing numbers of multi-mode terminals load balancing and optimisation of usage between the different systems, for example between the 2G GSM and the 3G WCDMA and the variants thereof, is becoming increasingly important. A way to do this is to transfer active services from a system to another. An example of suitable service to be moved between 2G and 3G systems is a circuit switched (CS) voice call as voice quality is practically the same in both networks. Furthermore, the interruption time during the handover is negligible in such a transfer.

Due to capacity limitations of the 3G networks it may be preferred to primarily hand over any dual-transfer mode (DTM) capable mobiles from 3G to 2G. The DTM refers to parallel circuit switched and packet switched (CS, PS) services in 2G. As there will initially also be many dual-mode mobiles not supporting DTM in 2G, the ones having DTM capabilities will most of the time be served by the 2G network.

Mobile users are provided with various services. The different services have different requirements for the networks and/or the user equipment. The availability, variety and use of different services is believed to increase as the networks are improved to provide more data carrying capacity and features enabling service providers to offer even more sophisticated services.

An example of the services are the so called real-time services, for example video or audio or other services wherein real-time data streaming is provided. Real-time services are expected to be increasingly popular amongst the users of mobile user equipment. A real-time service such as video streaming can be a high bitrate service that requires certain capability in the mobile user equipment and the network for enabling sufficiently high bitrates, which is generally more critical in the uplink from the user equipment to the base station. This data rate requirement is met based on different protocols and mechanisms in different networks.

Real-time video packet data services enable parallel communication of circuit switched voice and packet switched video. A typical use case is where there is an existing circuit switched voice call during which one party of the call wants to show something to the other party via video sharing, and requests for a packet switched video service while maintaining the voice call.

The DTM enabled 2G user equipment is in principle suitable for use of the real time video sharing service. However, because of the bitrate requirements by the packet switched video streaming, the video sharing service should be provided by the 3G if this is available. However, with the need for load balancing the circuit switched voice call will most likely be in the 2G at the time of making the packet switched video request. A problem is that with current implementations the video service first needs to be setup in the 2G system before it can be handed over to a 3G system. However, the video performance can be severely degraded in the 2G, for example if the cell or mobile user equipment does not support Enhanced General Packet Radio Service (EGPRS) or any other 2G upgrade providing sufficient bitrates. This is doe to various reasons, e.g. because the user has only one timeslot available in uplink and/or there is not enough free PS capacity in the 2G-cell.

It is noted that the problem is not limited to mobile communication systems, but may occur in any communication environment wherein user equipment may need to be transferred between different communications systems.

### SUMMARY OF THE INVENTION

Embodiments of the present invention aim to address one or several of the above problems.

According to an embodiment, there is provided a method for providing a further service for user equipment provided with a circuit switched service in a first communication system. In the method a request for a packet data service is received in the first communication system, where after the user equipment is transferred to a second communication system before establishing a data connection for the requested packet data service in the first communication system. A request for the packet data service is then processed in the second communication system, and the requested packet data service is provided for the user equipment by the second communication system.

According to another embodiment, there is provided a controller for a communication system. The controller is configured to process a request for a packet data service from user equipment provided with a circuit switched service by the communications system and to transfer the user equipment to a second communication system before establishing a data carrier for the requested packet data service in the first communication system.

According to another embodiment, there is provided a communication system for providing communication services for multi-mode user equipment. The communication system comprises a first communication system for providing at least a circuit switched service, a second communication system for providing at least a packet data service, a first controller in the first communication system configured to process a request for a packet data service and to transfer the user equipment to the second communication system before establishing a data carrier for the requested packet data service in the first communication system, and a second controller in the second communication system configured to process a request for the requested packet data service for providing the requested packet data service by the second communication system.

The packet data service may be requested from a second generation mobile communication network and then provided by a third generation mobile communication network.

The transfer of the user equipment to the second communication system may be triggered by reception of a request for a packet data service at the first communication system.

Processing of the request in the second communication system may comprise a procedure for resending a request for a packet data service. A timer value associated with a permission to re-request for a packet data service may be provided.

The embodiments may provide a simple way of moving a user from a network to another before a packet switched service is established. The embodiments may provide relatively short or no interruption times for the set-up of packet switched services. 2G/3G service interworking may be improved, and a good available quality of service can be offered in multi-call situations. In addition; users may be provided with high bitrate services even if these are not available in a network they are currently attached to.

### BRIEF DESCRIPTION OF DRAWINGS

For better understanding of the present invention, reference will now be made by way of example to the accompanying drawings in which:

FIG. 1 shows a communication system wherein the invention may be embodied; and

FIG. 2 is a flowchart illustrating an embodiment of the invention.

### DETAILED DESCRIPTION OF THE PREFERRED EMBODIMENTS

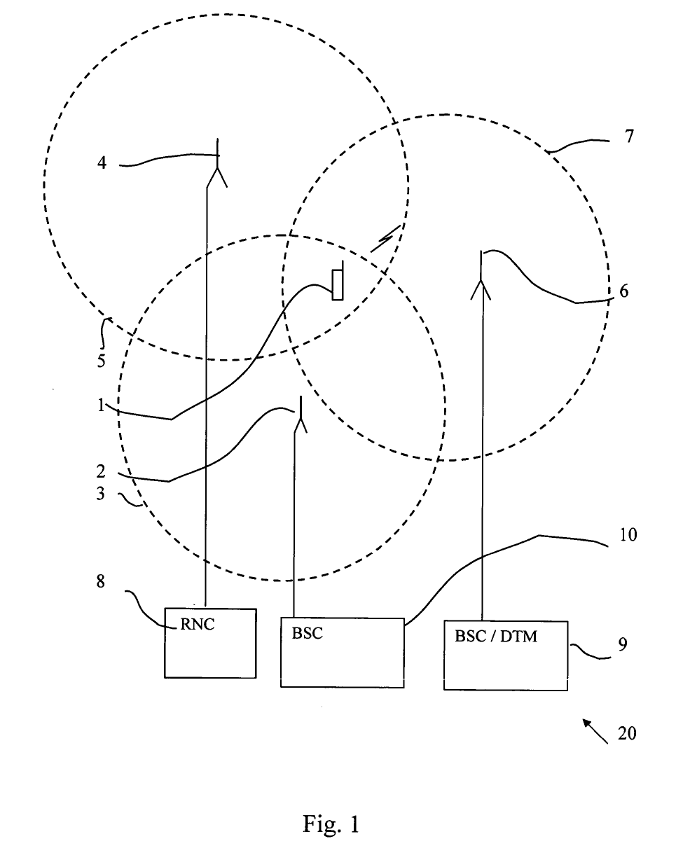

A reference is first made to FIG. 1 illustrating a communication system 20 wherein the invention can be embodied. The underlying communication system 20 of FIG. 1 may be provided by a plurality of mobile communication systems that are based on different standards.

In a typical mobile communication network, for example the cellular public landline mobile network (PLMN), a number of cells 3, 5 and 7 is provided by means of base stations 2, 4 and 6. Each base station is arranged to wirelessly transmit signals to and receive signals from a plurality of mobile user equipment 1 (only one shown for clarity). The wireless communication between the user equipment and cells can be based on any appropriate communication protocol and access technology. Non-limiting examples include access based on systems such as the CDMA (Code Division Multiple Access), WCDMA (Wide-band CDMA), TDMA (Time Division Multiple Access), FDMA (Frequency Division Multiple Access), or SDMA (Space Division Multiple Access) and hybrids thereof.

The multi-mode mobile user equipment 1 is able to transmit wireless signals to and receive signals from any of cells 3, 5 or 7. An appropriate user equipment is provided with required radio transmission elements and controller functions so that it is enabled to send and receive data from any of the networks, and process control instructions it may receive from or sent to the networks.

A mobile user equipment is able to move within a cell and also from one cell to another. In addition, a mobile user equipment may also be enabled to roam into another communication network of the mobile communication system. The basic principle of roaming is well known, and is not explained in here. What is important in view of the herein explained embodiment is that the user equipment 1 may roam within the area which is covered by cells 3 and 7, but not cell 5.

In a common wireless system an access network enables the user equipment to access the core part of a communication network that links the access network to other access networks or communication networks. Each access network is provided with at least one controller which may be connected to appropriate entities of the core network or networks. The core network is not shown.

Three cells 3, 5 and 7, base stations 2, 4 and 6, and access network controllers 8, 9 and 10 are shown in FIG. 1. For example, the third generation (3G) Wideband Code Division Multiple Access (WCDMA) networks cells are controlled by control entities known as radio network controllers (RNC). In the second generation (2G) GSM (Global System for Mobile) the cells of the access network are typically controlled by base station controllers (BSC). The difference between the two GSM access systems of FIG. 1 is that the cell 7 controlled by BSC 9 is configured to provide DTM services whereas the cell 3 controlled by BSC 10 is not.

In the herein described embodiment a multi-mode mobile user equipment 1 is moved in a 2G to 3G cell change, for example handover, from a 2G cell to a 3G cell. For example, a dual-mode (WCDMA/GSM) mobile user equipment may have an ongoing circuit switched voice call in the 2G cell 7. Both the mobile user equipment and the 2G-cell are thus DTM capable.

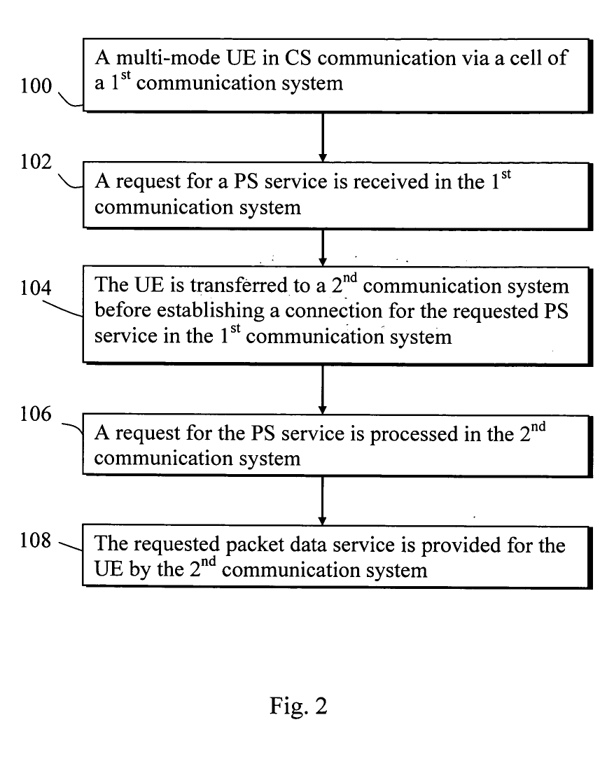

A reference is now made also to the flowchart of FIG. 2. In step 100 a user equipment is provided with circuit switched communication service via a cell of a first communication system, e.g. via cell 5 of the 2G system of FIG. 1. When the mobile user equipment 1 requests for a real time service at step 102, the user equipment 1 may need to be moved to the 3G cell 5 because of bandwidth requirements of the real time application. A 3G system is more likely to provide such a service than the DTM feature of the 2G system, and thus the user is likely to be better served by the 3G system. The multi-mode mobile user equipment involved in a circuit switched call is then transferred at step 104 from a lower capacity system to a higher capacity system just before, or while, the high bitrate packet data service is being establised, and in any case before the establisment procedure is completed.

The user is preferably moved to the 3G communication system substantially soon after a controller of the 2G network, for example the GSM BSC 9 or a serving general packet radio service support node (SGSN), receives a service request. The transfer from the 2G system to the 3G system may be handled, for example, by means an inter-system handover of an on-going circuit switched voice call.

The transfer of a user may be triggered by various events. For example, moving or “upgrading” of a user can be triggered by a DTM call establishment message. For example, “DTM REQUEST” message may be used as a trigger when a video call is mobile originated. A downlink logical link control packet data unit (DL LLC PDU) or a “page request” message may be used when a video call is mobile terminated.

The request is then handled in the 2^{nd} communication system at step 106 to provide the requested packet data service for the user equipment at step 108.

It may be that the 3G system has no capacity at the moment, or that the transfer should not occur e.g. because of load balancing reasons. It may therefore be desired to have a check if and/or rule when the transfer may occur. The decision to transfer to 3G may be based on various criteria, such as 2G cell capacity, 2G cell load, 3G neighbour cell load, requested QoS (quality of service), user equipment capabilities, user profile, and so forth.

After the transfer, the request for a video call may need to be repeated as soon as the mobile user equipment 1 is connected to the 3G system. The re-requesting of the video call may be handled by the RTVS implementation in the mobile. For example, if the user equipment knows in which system it is, the service application may simply request again for the packet switched service as soon as it is in a 3G system.

A possibility is to define that the re-requesting procedure takes place in response to a predefined message. For example, the re-requesting procedure could follow a 3GPP “DTM REJECT” message. The predefined message may be any message that includes the permission for a reattempt of the packet data carrier or otherwise allows the system to reattempt packet data carrier establishment after a predefined time, e.g. after X seconds. It may also be defined that the reattempt can be performed as soon as possible (i.e. the timer is skipped) if the user equipment was moved to the higher capacity network during the X seconds waiting time. The latter approach may even be desired in certain applications as it may reduce waiting time.

If a network element such as a combined 2G/3G-SGSN (serving GPRS support node) is used, then it is possible to provide the request handling within the network element. For example, the SGSN can be made aware of the request where after it may proceed with it when the terminal is in the 3G system. It is also possible to define in respective communication standards and/or protocols that a packet switched request shall be repeated directly, for example after an inter-system handover, without any additional commands or events.

The required data processing functions may be provided by means of one or more data processors. Appropriately adapted computer program code product may be used for implementing the embodiments, when loaded to a computer, for example for performing the computations and requesting, interpretation and decision operations. The program code means are preferably be provided in a controller of a cell wherein user equipment is located before the transfer thereof is initiated. The program code product for providing the operation may be stored on and provided by means of a carrier medium such as a carrier disc, card or tape. A possibility is to download the program code product via a data network.

The embodiments may also enable user equipment that do not support a particular packet switched service in the 2G to be moved to 3G by simply sending a request doe the service when being connected to the 2G network.

It is noted that the invention is not limited to video streaming. That is only an example of the packet switched services.

The embodiment enables transfer of a user into a 3G system before a video call of other packet switched service is established in a relatively simple manner since only an inter-system handover of the circuit switched voice call is required. This handover is a relatively fast and reliable procedure. The end-user does not necessarily experience any degraded service performance while being in 2G with video. Furthermore, the 2G to 3G interruption time for packet switched services may be avoided. Thus 2G/3G service interworking may be improved, and a good available quality of service can be offered in multi-call situations.

It is noted that whilst embodiments of the present invention have been described in relation to user equipment such as mobile stations, embodiments of the present invention are applicable to any other suitable type of user equipment.

It is also noted that the concepts of cell change and movement or transfer from a cell to another refer to any operation wherein user equipment is transferred from a cell to another, and thus refers to operations such as packet switched cell change, circuit switched handover and so forth.

It is noted that even though the exemplifying communication system shown and described in more detail in this disclosure uses the terminology of the 3^{rd} generation (3G) WCDMA (Wideband Code Division Multiple Access) networks, such as UMTS (Universal Mobile Telecommunications System) or CDMA2000 public land mobile networks (PLMN) and 2G GSM, embodiments of the proposed solution can be used in any communication system wherein advantage may be obtained by means of the embodiments of the invention. The invention is not limited to environments such as cellular mobile or WLAN systems either. What is required is that system level information of a first type of network can be used by a controller of another type network for selection of an access entity of the first type of network, and that the controller is enabled to command user equipment to choose a selected access entity. Thus the term cell is understood to refer broadly to an access entity that is provided by a communications network.

It is also noted herein that while the above describes exemplifying embodiments of the invention, there are several variations and modifications which may be made to the disclosed solution without departing from the scope of the present invention as defined in the appended claims.

1. A method for providing a further service for user equipment that is provided with a circuit switched service in a first communication system, comprising:
receiving a request for a packet data service in the first communication system;
transferring the user equipment to a second communication system before establishing a data connection for the requested packet data service in the first communication system;
processing a request for the packet data service in the second communication system; and
providing the requested packet data service for the user equipment by the second communication system.

2. A method according to claim 1, wherein the step of providing the requested packet data service for the user equipment comprises providing the requested packet data service by a third generation mobile communication network.

3. A method according to claim 1, wherein the step of requesting the packet data service from the first communication system comprises requesting the packet data service from a second generation mobile communication network.

4. A method according to claim 1, wherein the step of transferring the user equipment to the second communication system is triggered by reception of the request for the packet data service at the first communication system.

5. A method according to claim 1, wherein the step of transferring is triggered by a dual-transfer mode message.

6. A method according to claim 1, comprising transferring the circuit switched service from the first communication system to the second communication system.

7. A method according to claim 6, wherein the transfer of the circuit switched service comprises an inter-system handover of an on-going voice call.

8. A method according to claim 1, wherein the step of processing a request for the packet data service in the second communication system comprises a procedure for resending a request for a packet data service.

9. A method according to claim 8, comprising resending the request from the user equipment.

10. A method according to claim 8, comprising initiating the step of resending the request in a controller of the second communication system.

11. A method according to claim 1, comprising the further step of sending a timer value associated with a permission to re-request for a packet data service in the second communication network.

12. A method according to claim 11, comprising ignoring a remaining time of the timer value as soon as it is possible to repeat the request for the packet data service in the second communication system.

13. A method according to claim 1, wherein the request for a packet data service comprises a request for a real time packet data service.

14. A method according to claim 1, wherein the request for a packet data service comprises a request for a real time video service.

15. A method according to claim 1, wherein the step of transferring the user equipment to the second communication system is initiated before initiation of a procedure to establish a data connection for the requested packet data service in the first communication system.

16. A computer program embodied on computer-readable medium comprising program code means configured to perform the steps of claim 1, when the program is run on a computer.

17. An access network controller comprising a computer program code means according to claim 16.

18. A controller for a communication system, the controller being configured to process a request for a packet data service from user equipment provided with a circuit switched service by the communications system and to transfer the user equipment to a second communication system before establishing a data carrier for the requested packet data service in the first communication system.

19. A communication system for providing communication services for multi-mode user equipment, comprising:
a first communication system for providing at least a circuit switched service;
a second communication system for providing at least a packet data service;
a first controller in the first communication system configured to process a request for a packet data service and to transfer the multi-mode user equipment to the second communication system before establishing a data carrier for the requested packet data service in the first communication system; and
a second controller in the second communication system configured to process a request for the requested packet data service for providing the requested packet data service by the second communication system.

20. A communication system according to claim 19, wherein the first controller comprises a base station controller of a second generation mobile communication network.

21. A communication system according to claim 19, wherein the second controller comprises a radio network controller of a third generation mobile communication network.

22. A communication system according to claim 19, wherein the first controller and second controller are provided by a network element.

23. A communication system according to claim 19, wherein the second communication system is configured to handle a repeat request for the requested packet data service.

24. A communication system according to claim 19, wherein the first controller is configured to trigger the transfer of the multi-mode user equipment to the second network in response to a request for a packet data service.

25. A communication system according to claim 19, wherein the first controller is configured to trigger the transfer of the user equipment to the second network in response to a dual-transfer mode message.

26. A communication system according to claim 19, comprising a timer for allowing sending of a repeat request for the requested packet data service.

27. A communication system according to claim 19, wherein the request for a packet data service comprises a request for a real time packet data service.
